(19) United States
(12) Patent Application Publication
(10) Pub. No.: US 2006/0169475 A1
(43) Pub. Date: Aug. 3, 2006

(54) Cable fluid injection sleeve

(75) Inventors: Glen J. Bertini, Tacoma, WA (US); Bernd Grave, Neubiberg (DE); Keith Lanan, Renton, WA (US); Albert W. Chau, Woodinville, WA (US); William R. Stagi, Burien, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: UTILX Corporation, Kent, WA (US)

(21) Appl. No.: 11/195,345

(22) Filed: Aug. 2, 2005

Related U.S. Application Data
(63) Continuation of application No. 10/792,019, filed on Mar. 3, 2004, now abandoned.
Application No. 10/792,019 is a continuation of application No. 09/471,816, filed on Dec. 22, 1999, now abandoned.
Application No. 09/471,816 is a continuation of application No. 09/085,385, filed on May 27, 1998, now abandoned.
Application No. 09/085,385 is a continuation-in-part of application No. 08/799,547, filed on Feb. 13, 1997, now Pat. No. 5,907,128.

(51) Int. Cl. H01R 9/05

(52) U.S. Cl. 174/74 R

(57) ABSTRACT

A connector for repairing and connecting at least one section of a first electrical cable having an outer surface, an interior end, an exterior end, and a central conductor portion. The connector includes a sleeve having first and second open ends, and a hollow interior to permit the passage of fluid therethrough. The connector also includes a port providing fluid communication with the hollow interior of the sleeve and into the central conductor portion of the first electrical cable. The sleeve is capable of receiving and forming a fluid-tight seal with the interior end of the first electrical cable.

### CROSS-REFERENCE TO RELATED APPLICATIONS

This application is a continuation of application Ser. No. 10/792,019, filed Mar. 3, 2004, which is a continuation of application Ser. No. 09/471,816, filed Dec. 22, 1999, now abandoned, which is a continuation of application Ser. No. 09/085,385, filed May 27, 1998, now abandoned, which is a continuation-in-part of application Ser. No. 08/799,547, filed Feb. 13, 1997, now U.S. Pat. No. 5,907,128, the disclosures of which are all hereby expressly incorporated by reference.

### FIELD OF THE INVENTION

The invention relates to electrical cable connectors, such as splices; and further relates to conduits, or the like, for injection of fluid into the interior of electrical cables.

### BACKGROUND OF THE INVENTION

Beginning in the post-war construction boom of the late 1950s and early 1960s, overhead electrical cable lines were recognized as an eyesore. Underground electrical cable technology was developed and implemented due to its aesthetic advantages and reliability. Underground electrical cable, a medium voltage cable that carries from 5,000 volts to 35,000 volts with an average voltage of 15,000 volts, initially employed high molecular weight polyethylene (HMWPE) polymer as the insulation of choice due to its low cost and ease of manufacturing. Subsequently, cross-linked polyethylene (XLPE) and ethylene propylene rubber (EPR) replaced high molecular weight polyethylene as the insulation. More recently, a water damage retardant formulation has also been included in these newer types of insulation.

Underground electrical cable was initially touted as having a useful life of from 25 to 40 years. However, the useful life of underground cable has rarely exceeded 20 years, and has occasionally been as short as 10 to 12 years. Catastrophic failure of older HMWPE, XLPE, and EPR cable is now beginning to occur due to water damage known as “water trees.” Water trees are formed in the polymer when medium to high voltage alternating current is applied to a polymeric dielectric (insulator) in the presence of liquid water and ions. As water trees grow, they compromise the dielectric properties of the polymer until the insulation fails. Many large water trees initiate at the site of an imperfection or contaminant, but contamination is not a necessary condition for water trees to propagate:

Water tree growth can be eliminated or retarded by removing or minimizing the water or ions, or by reducing the voltage stress. Voltage stress can be minimized by employing thicker insulation. “Clean room” manufacturing processes can be used to both eliminate ion sources and minimize defects or contaminants that function as water tree growth sites. Another approach is to change the character of the dielectric, either through adding water tree retardant chemicals to polyethylene or by using more expensive, but water tree resistant, plastics or rubbers. All of these approaches have merit, but only address the performance of electrical cable yet to be installed.

For electrical cables already underground, the options are more limited. First, the entire failing electrical cable can be replaced, but the cost is often prohibitive. Second, the points of failures due to water tree propagation can be excised and the removed portions replaced with a splice. Unfortunately, since water trees are not identifiable until after cable failure occurs, splicing after cable failure results in a power interruption to the electric utility customers. Third, the cable can be dried with a desiccant fluid such as nitrogen in order to remove the water that initiates the water tree. While this approach improves the dielectric properties of the underground cable, it requires perpetual maintenance to replace large and unsightly nitrogen bottles that remain coupled to the cable.

A more promising approach to retard failure of underground cable is to inject a silicone fluid such as, for example, CABLECURE®, into the electrical cable conductor strands. CABLECURE reacts with water in the underground cable and polymerizes to form a water tree retardant that is more advanced than those used in the manufacture of modern cables. The dielectric properties of the cable are not only stabilized by CABLECURE, but actually improved dramatically.

However, the devices and methods used to treat underground electrical cables with CABLECURE do have drawbacks. Different methodologies are employed depending upon the type of cable being treated. There are two main classes of cables, underground residential distribution (URD) cables which are relatively small cables, and feeder cables, which are larger cables which often supply the URD cables.

Regarding the treatment of feeder cables with CABLECURE, a major problem is the ability of splices which are often encountered in the feeder cable to hold the pressure required to inject perhaps miles of the feeder cable with CABLECURE. The larger the overall cable diameter, the larger the splice, and the higher the hoop forces created by the pressurization of the cable cavity. Due to the large diameter of feeder cables, there is seldom sufficient hoop strength in the typical splices to withstand the basic vapor pressure of the CABLECURE without leaking, not to mention the increased pressurization required to transport the CABLECURE along the miles of feeder cable. A leak of CABLECURE in the splice can create a contaminated path along the splice interface which may lead to eventual failure of the splice.

To avoid the problem of CABLECURE leaking at splices, one of two approaches have been employed for injection of CABLECURE into feeder cables. First, the splice can be reinforced with clamps or other devices to increase its hoop strength. However, this approach is limited because the force necessarily applied by the hose clamps or other reinforcement devices on the splice is so large that there is substantial deformation of the rubber material used to make the splice. The deformation compromises the geometrical and electrical integrity of the splice and thus provides only a slight increase in injection pressure tolerance. A second approach is to remove the splice prior to injecting the two separated segments of the electrical cable with CABLECURE, then injecting CABLECURE, and finally injecting a second damming chemical compound into the two electrical cable segments that physically blocks the migration of the CABLECURE into a new splice that is applied to the two cable segments after the CABLECURE treatment has been completed. An example of a damming compound is a combination of dimethylsilicone polymers with vinyl cross-linker and a suitable catalyst. In addition to low viscosity and quick cure times, a damming fluid must be compatible with all cables, splices and other components. Drawbacks with the above method of employing a damming compound include the additional cost of the expensive damming compound, the necessity to install a new splice, and the possibility that the CABLECURE may compromise the structural integrity of the new splice if the physical partition formed by the damming compound fails.

Further, it has been learned that injection of damming compounds into even short lengths near the end of a cable can create transient discontinuities in the penetration of the dielectric enhancement fluid. These discontinuities of penetration create discontinuous treatment, which at a minimum leaves some small section of the cable untreated for a longer period of time, increasing the risk of a post treatment dielectric failure. Further, there is a potential that these discontinuities can even lead to local electrical stress increases which may contribute to a failure in the region where the dam interferes with uniform penetration. Since the point of injecting cable is to increase its reliability and mitigate its proclivity to fail, the use of either reinforcing devices or damming compounds to handle sufficient injection, vapor and elevation-induced pressure are not ideal solutions.

CABLECURE injection can also be employed to treat water tree damage in URD cables. Since the diameter of the URD cables is less than that of feeder cables, the splices in URD cables can withstand the vapor pressure of CABLECURE. Additionally, due to the typically shorter lengths of the URD cables, a lower pressure (0-30 psig) than the pressure employed in feeder cables is required to transport the CABLECURE through the URD cable; therefore, the splices in the URD cable are not subjected to the moderate pressures (30-120 psig) desired to inject typically longer feeder cable and their integral splices. However, because an URD cable does not have enough interstitial volume in the strands of the cable to hold sufficient CABLECURE for maximum dielectric performance, URD cables require an extended soak period of 60 days or more to allow for additional CABLECURE to diffuse from the cable strands into the polyethylene. When very long URD cables or URD cables with large elevation changes are encountered, moderate to medium (120-350 psig) pressure injection of CABLECURE may be required. The moderate to medium pressure addition of CABLECURE to an URD cable therefore necessitates removing the splices during the treatment of the cable, followed by adding new splices after the treatment.

A need thus exists for devices and methods whereby expensive damming compounds are not required to block the contact of repair chemicals with the replacement splice in feeder cables.

A need also exists for devices and methods in which both a separate conduit for injecting CABLECURE into a feeder cable as well as a separate replacement splice are not required.

A further need exists for devices and methods in which repair chemicals can be injected into URD cables at moderate to medium pressures without compromising the structural integrity of splices.

### SUMMARY OF THE INVENTION

In accordance with the present invention, a connector for a first information transmitting cable is provided. The transmitting cable includes an outer surface, an interior end, an exterior end, and a central conductor portion. The connector includes a conduit having open ends, each open end of the conduit adapted to receive the interior end of the first information transmitting cable. The conduit includes a hollow interior to permit the passage of a fluid therethrough. The conduit is capable of forming a fluid-tight seal between the conduit and a portion of the first information transmitting cable. In one embodiment of the present application, the conduit further includes an injection port to provide fluid communication with the hollow interior of the conduit and pass fluid therethrough and into the central conductor portion of the information transmitting cable.

In accordance with other aspects of this invention, the injection port is an internally threaded opening. In accordance with additional aspects of this invention, the conduit further includes an internally threaded plug sealingly received within the injection port.

In accordance with still yet other aspects of this invention, a tube is sealingly received within the injection port, wherein the tube includes a restraint integrally formed with the tube to resist withdrawal of the tube from within the injection port. In one embodiment, the restraint includes a first angularly disposed fin. In another embodiment, the restraint is a plurality of angularly disposed fins.

In still yet additional aspects of this invention, the connector further includes a second information transmitting cable having an outer surface, an interior end, an exterior end, and a central conductor portion. The second information transmitting cable is adapted to be received within the other of the open ends of the conduit, wherein the first and second information transmitting cables are electric cables.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view, partially exposed, of a cable connector of the present invention;

FIG. 2 is a side view of the cable connector of the present invention;

FIG. 3 is a side view of a first embodiment of the cable connector of the present invention secured to a cable for injection of cable damage repair chemicals therethrough and for electrical connection of the cable with a second cable;

FIG. 4 is a side view of a second embodiment of the cable connector of the present invention secured to a cable for injection of cable damage repair chemicals therethrough and for electrical connection of the cable with a second cable;

FIG. 5 is a side view, partially exposed, of a third embodiment of the cable connector of the present invention secured to a cable for injection of cable damage repair chemicals therethrough and for electrical connection of the cable with a second cable;

FIG. 6 is a detail view of FIG. 5;

FIG. 7 is a side view, partially exposed, of a fourth embodiment of the cable connector of the present invention secured to a cable for injection of cable damage repair chemicals therethrough and for electrical connection of the cable with a second cable;

FIG. 8 is a side view of a fifth embodiment of the cable connector of the present invention secured to a cable for injection of cable damage repair chemicals therethrough and for electrical connection of the cable with a second cable;

FIG. 9 is a side view of a sixth embodiment of the cable connector of the present invention secured to a cable for injection of cable damage repair chemicals therethrough and for electrical connection of the cable with a second cable;

FIG. 10 is a side view of first and second electrical cable sections prepared for connection by a seventh embodiment of the cable connector of the invention;

FIG. 11 is a side view of the interior connector components of the seventh embodiment of the cable connector of the present invention arranged on the first and second electrical cable sections prior to installation;

FIG. 12 is a partially exposed side view showing the attachment of the conduit of the interior connector of the seventh embodiment of the cable connector of the present invention to the first and second electrical cable sections;

FIG. 13 is a side view showing a first sealing step for providing a fluid tight seal at the joints of the conduit with the first and second electrical cable sections of FIG. 12;

FIG. 14 is a side view showing a second sealing step for providing a fluid tight seal at the joints of the conduit with the first and second electrical cable sections of FIG. 12;

FIG. 15 is a side view showing attachment and heat shrinking of the stress control tubing over the conduit of the interior connector of the cable connector of the seventh embodiment of the present invention;

FIG. 16 is a side view showing attachment and heat shrinking of the insulation sleeve over the stress control tubing of the interior connector of the cable connector of the seventh embodiment of the present invention;

FIG. 17 is a side view showing heat shrinking of the compression rings over the ends of the stress control tubing of the interior connector of the cable connector of the seventh embodiment of the present invention;

FIG. 18 is a side view showing the application of metal wrap over the stress control tubing of the interior connector of the cable connector of the seventh embodiment of the present invention;

FIG. 19 is a side view showing the reconnection of the optional shielding wires of the first and second electrical cable sections;

FIG. 20 is a side view showing the application of a second metal wrap when shielding wires are present;

FIG. 21 is a side view showing the attachment and heat shrinking of the outer sheath over the second metal wrap of the interior connector of the cable connector of the seventh embodiment of the present invention;

FIG. 22 is a side view showing the interior connector of the cable connector of the seventh embodiment of the present invention completely installed between first and second electrical cable sections;

FIG. 23 is a partially exposed side view of the sleeve of the injection fitting of the seventh embodiment of the cable connector of the present invention attached to the exterior end of the cable section and to conductor contact;

FIG. 24 is an exposed detail view of a first embodiment of the fluid injection opening of the sleeve of the injection fitting of the seventh embodiment of the cable connector of the present invention;

FIG. 25 is an exposed detail view of a second embodiment of the fluid injection opening of the sleeve of the injection fitting of the seventh embodiment of the cable connector of the present invention;

FIG. 26 is an exposed detail view of a third embodiment of the fluid injection opening of the sleeve of the injection fitting of the seventh embodiment of the cable connector of the present invention;

FIG. 27 is an exposed detail view of a fourth embodiment of the fluid injection opening of the sleeve of the injection fitting of the seventh embodiment of the cable connector of the present invention; and

FIG. 28 is an exposed detail view of a fifth embodiment of the fluid injection opening of the sleeve of the injection fitting of the seventh embodiment of the cable connector of the present invention.

### DETAILED DESCRIPTION OF THE PREFERRED EMBODIMENT

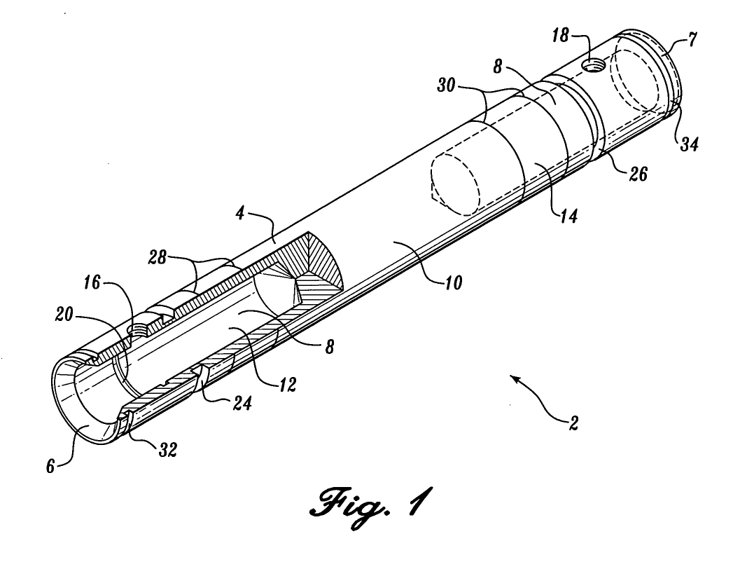

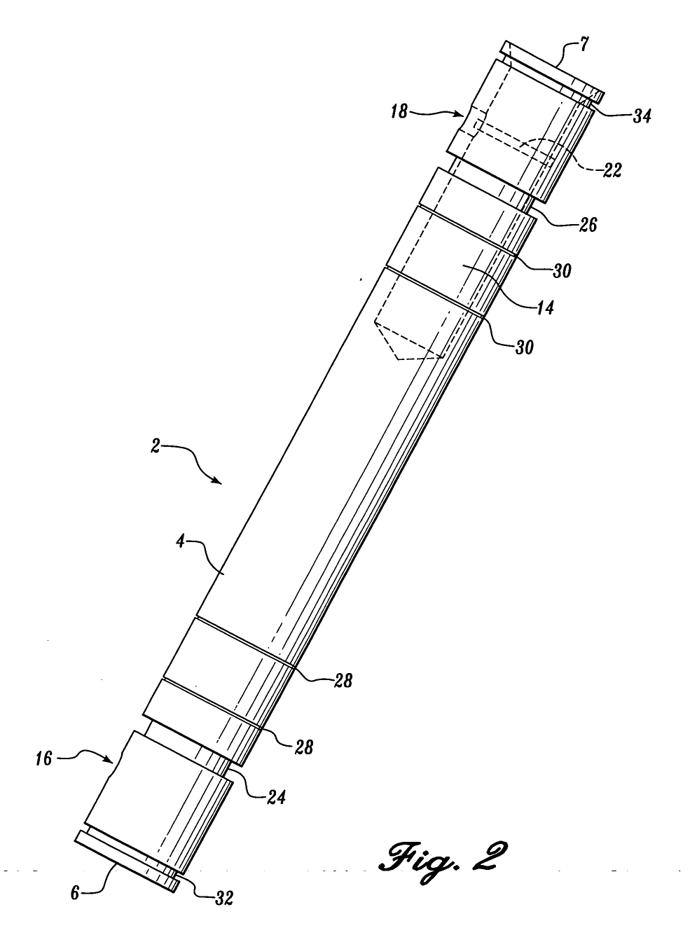

FIGS. 1 and 2 depict a cable connector 2 of the present invention in the form of an elongate conduit which may be, for example, a tube, pipe or any other similarly shaped device capable of fluid transport. The cable connector has an exterior 4, ends 6 and 7, and an interior 8 that is divided by an interior wall 10 into two hollow portions 12 and 14. The hollow portions 12 and 14 are each sized and shaped to receive an end of an electrical cable or cable section. A portion of a cable that has been stripped to remove the outer insulation from the cable is inserted into each hollow portion. The ends of the cables are then secured to the cable connector by crimping each end 6 and 7 of the connector. Crimping guides 28 and 30 are provided on the exterior 4 of the connector to demark the appropriate location of crimping. Strain relief grooves 24 and 26 are located on the exterior 4 of the cable connector adjacent the crimping guides 28 and 30, respectively, and provide relief from strain forces generated as the cable connector is crimped.

Two orifices 16 and 18 are provided in the ends 6 and 7 of the cable connector 2 to allow a cable damage repair chemical to be injected into the cable. Orifice 16 communicates with the hollow portion 12 of the cable connector, and orifice 18 communicates with the hollow portion 14. Each orifice 16 and 18 is preferably threaded to allow the orifice to be closed after chemicals have been pumped through the orifice, as described in further detail below. To facilitate even fluid flow through the interior 8 of the cable connector, interior circumferential grooves 20 and 22 are formed around the interior of the hollow portions 12 and 14, respectively. The interior grooves 20 and 22 preferably intersect orifice 16 and orifice 18, respectively, to channel chemicals pumped through the orifice around the exterior of each cable contained in the ends of the cable connector.

The exterior 4 of the cable connector 2 is also formed with circumferential seal grooves 32 and 34 adjacent the ends 6 and 7 of the connector, respectively. The seal grooves are sized to receive an O-ring or other seal known in the art, to optionally provide an enhanced seal between the cable connector 2 and electrical cable sections or cables, as described in further detail below.

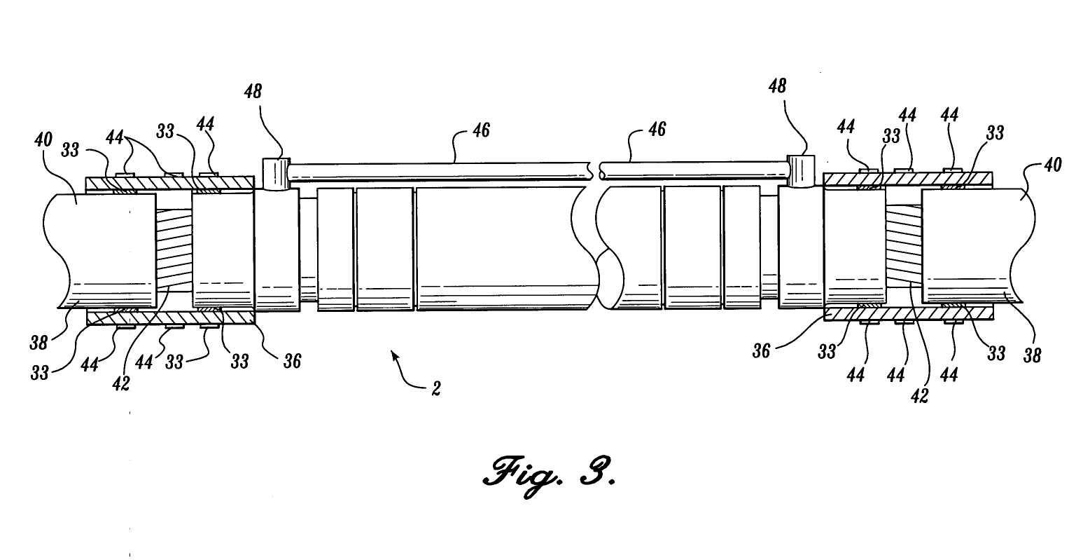

FIG. 3 shows a first embodiment for attachment of the cable connector 2 to an electrical cable in which an O-ring or other seal is not employed in seal groove 32, and seal groove 32 is not present. Instead, broad band seals 33 can be employed between sheath 36 and connector 2 and cable 38. Alternatively, sheath 36, itself, may provide a tight enough seal without seals if sheath 36 is, for example, vinyl. Also, instead of broad band seals 33, an adhesive can be employed between sheath 36 and connector 2 and cable 38. As shown in FIG. 3, sheath 36 is initially placed over the end 6 of the cable connector 2. The sheath 36 is preferably comprised of a liquid tight material that can be either resilient or can have heat-shrink properties and can be, for example, rubber, vinyl, polyethylene, or nylon. Cable 38 that is comprised of, for example, cable insulation 40 and cable strands 42, is inserted into the end of the cable connector and secured in the hollow portion 12 by crimping the connector. Optional sheath connectors 44, which may be, for example, steel bands or clamps, or other material with high tensile strength, may be placed around the sheath 36 to provide additional hoop strength to secure the sheath 36 at the juncture of the end 6 of cable connector 2 and the cable insulation 40 of the cable 38.

Once the cable 38 is secured to the cable connector 2, cable water-damage repair chemicals, such as, for example, a silicone fluid (CABLECURE®), may be injected into the cable 38. The repair chemicals are supplied from a pressure source known in the art through a tube 46 in communication with a tube fitting 48. Tube fitting 48 is preferably threadedly mateable with orifices 16 and 18, and preferably also functions as a closure device. As shown in FIG. 3, after passing through tube fitting 48, the silicone fluid flows through orifice 16, into hollow portion 12, where it contacts cable strands 42 of cable 38, passes out of end 6 of elongate conduit 2 and into cable 38 for a predetermined distance. After sufficient silicone fluid has been injected into the cable the tube 46 is removed. The tube fitting 48 may remain in the orifices 16 and 18 and may be plugged to the orifices 16 and 18, or tube fitting 48 may be removed and a plug fitting installed in orifices 16 and 18.

After termination of cable water-damage repair chemical treatment and after the tube 46 is detached from the tube fitting 48, the electrical cable or cable sections are electrically energized. It will be appreciated that because the cable connector 2 is electrically conductive, cable 38 is electrically connectable to any other cable also attached to the cable connector. Note that while FIG. 3 only shows and describes the chemical repair and electrical connection of a single cable 38 to the cable connector 2 at end 6, it is understood that a second cable can be attached at end 7 of the cable connector 2 for a similar chemical repair and electrical connection. In other words, the present invention encompasses both a cable connector 2 having only an end 6 and not an end 7 to secure only a single cable 38 with some other known electrically conductive connection to other devices in place of end 7, as well as a cable connector 2 having both an end 6 and an end 7 to secure, repair and electrically connect two cables 38.

Referring to FIG. 4, a second embodiment of the present invention is shown which is similar to the first embodiment of the present invention of FIG. 3 and in which the same element numbers are used as in FIG. 3 to describe like elements. The primary difference between the first embodiment of FIG. 3 and the second embodiment of FIG. 4 is that in the second embodiment of FIG. 4, an O-ring or seal 50 is located in the seal groove 32 adjacent the end 6 of the cable connector 2. The seal 50 is therefore located between the end 6 of the cable connector 2 and the sheath 36. A second seal 50 is also located between the sheath 36 and the cable insulation 40 of cable 38. Additionally, sheath 36 is bowed such that concave portions are present for the placement of seals 50 between sheath 36 and cable 38, and between sheath 36 and the end 6 of the cable connector 2, respectively. Additionally, sheath 36 is bowed such that a convex center portion provides additional closure at the juncture of attachment of cable 38 in end 6 of the cable connector 2.

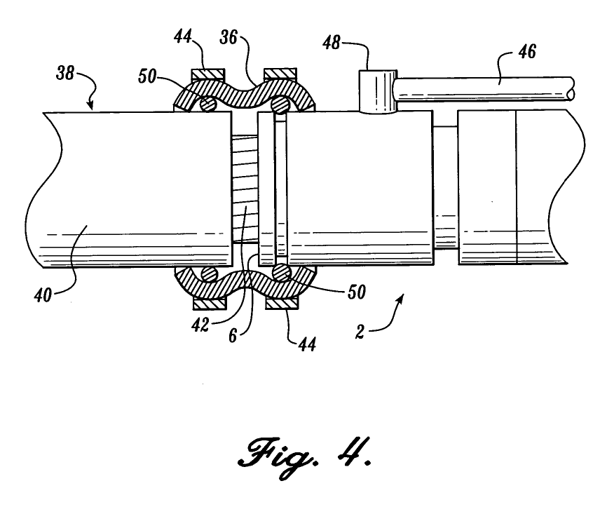

Referring to FIGS. 5 and 6, a third embodiment of the present invention is shown in which the same element numbers are used as are used in FIG. 3, which shows the first embodiment, to describe like elements. The primary difference between the first embodiment of FIG. 3 and the third embodiment of FIGS. 5 and 6 is that the third embodiment of FIGS. 5 and 6 does not employ a sheath 36 at the juncture of the end 6 of cable connector 2 and the insulation 40 of the cable 38. Instead, a threaded seal 52 is located at the juncture of end 6 of cable connector 2 and insulation 40 of cable 38. Threaded seal 52 is comprised of a preferably annular inner seal member 54 having an exterior surface 56. On exterior surface 56 are threads 58. Compression ring 59 is located on inner seal member 54 with O-ring seal 57 located therebetween. Threaded seal 52 also includes outer seal member 60 which is preferably annular, and which has threads 64 thereon that are mateable with threads 58 of inner seal member 54. Elastomeric packing 68 is located between the junctures of both compression ring 59 and inner seal member 54 with insulation 40 of cable 38, and elastomeric packing 69 is located between inner seal member 54 and end 6 of cable connector 2. Inner seal member 54 has a passageway 70 therethrough for passage of cable water-damaged repair chemicals through threaded seal 52 and into contact with cable strands 42 of cable 38, in a manner described above for the first embodiment of the present invention. In operation, threaded interconnection of inner seal member 54 and outer seal member 60 imparts an axial force through compression ring 59 and into elastomeric packing 68 while inner seal member 54 imparts an opposite axial force on elastomeric packing 69 to form a complete seal. Note that in the third embodiment, connector 2 can be a connector known in the art, with the elements of the third embodiment being located over cable strands 42 and between insulation 40 and connector 2.

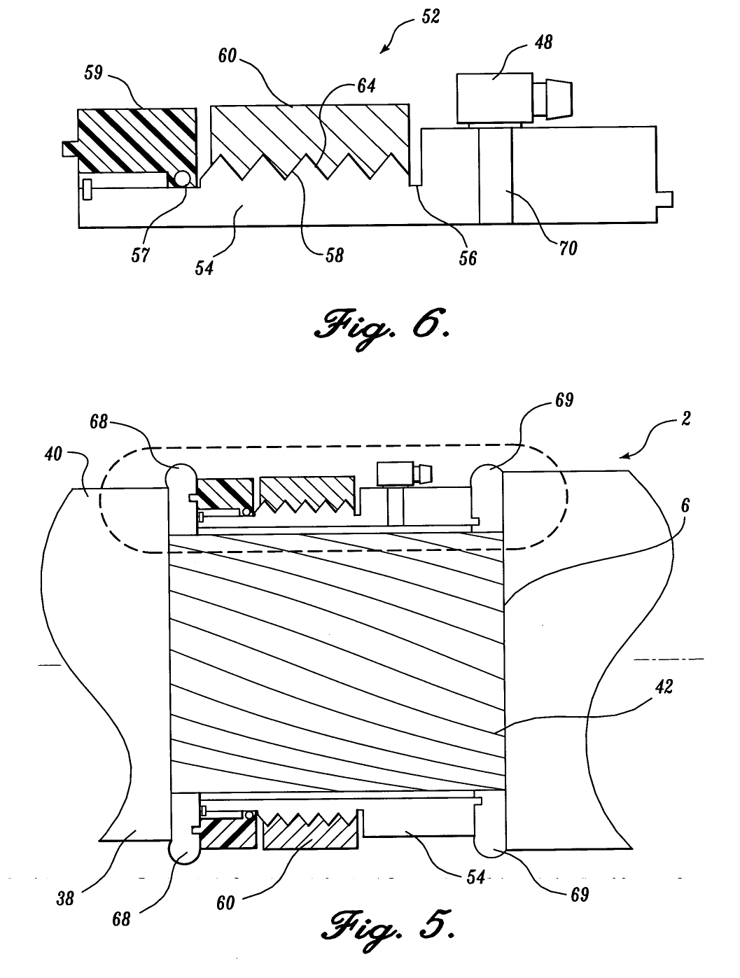

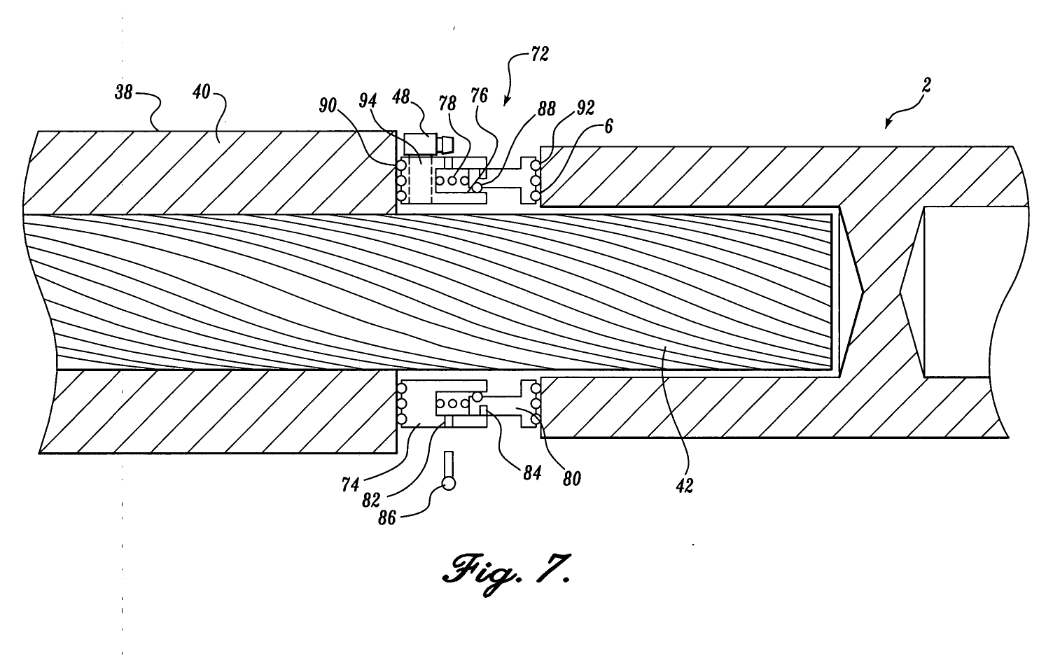

Now referring to FIG. 7, a fourth embodiment of the present invention is shown which includes elements described in the first embodiment of the present invention of FIG. 3, these elements having like element numbers to those in the first embodiment of FIG. 3. Unlike the first embodiment of the present invention of FIG. 3 in which sheath 36 is located at the juncture of the end 6 of cable connector 2 and insulation 40 of cable 38, in the fourth embodiment of the invention of FIG. 7, spring seal 72 is employed. Spring seal 72 is comprised of a spring receptacle portion 74 which is preferably annular in shape and which has a hollow interior 76 which is sized to receive spring 78. Spring seal 72 also includes annular elongate portion 80 which is mateable with hollow interior 76 of spring receptacle portion 74 to compress spring 78 when spring seal 72 is secured. Hole 82 passes through spring receptacle portion 74, communicates with hollow interior 76 thereof, and is coaxially aligned with hole 84 when elongate portion 80 is inserted into hollow interior 76 of spring receptacle portion 74. Pin 86 is adapted to pass through hole 82 of spring receptacle portion 74 and hole 84 of elongate portion 80 to lock elongate portion 80 in spring receptacle portion 74. O-ring-type seal 88 is present between elongate portion 80 and spring receptacle portion 74 in hollow interior 76 thereof; O-ring-type seal 90 is present between spring receptacle portion 74 and insulation 40 of cable 38, and O-ring-type seal 92 is present between elongate portion 80 and end 6 of cable connector 2 to provide a fluid-tight environment through which cable repair chemicals can pass. Passageway 94 is located through spring receptacle portion 74 to allow cable repair chemicals to pass through spring seal 72 and contact cable strands 42 of cable 38.

Referring to FIG. 8, a fifth embodiment of the present invention is shown having elements that are also present in the first embodiment of the present invention of FIG. 3, these like elements having the same element numbers as those used in the first embodiment of FIG. 3. Unlike the first embodiment of the present invention of FIG. 3 in which sheath 36 is located at the juncture of the end 6 of cable connector 2 and insulation 40 of cable 38, in the fifth embodiment of FIG. 8, a fluid-tight connection between cable 38 and connector 2 is created by cable shoulder 98 which is defined by first portion 100 of insulation 40 having a standard outside diameter and by a second portion 102 of insulation 40 having an outside diameter less than the outside diameter of first portion 100 of insulation 40 of cable 38. A seat 104 in hollow portion 12 of interior 8 of connector 2 is mateable with shoulder 98. More specifically, seat 104 includes first portion 106 that has an inside diameter less than the outside diameter of second portion 102 of insulation 40, and also includes a second portion 108 that has an inside diameter greater than the outside diameter of second portion 102 of insulation 40. Thus, second portion 102 of insulation 40 is insertable into second portion 108 of hollow portion 12, but second portion 102 of insulation 40 has an outside diameter too great to clear the lesser inside diameter of first portion 106 of hollow portion 12 such that shoulder 98 of insulation 40 mates with seat 104 of hollow portion 12 and abuts against end 6 of connector 2. To further ensure a fluid-tight fit between cable 38 and connector 2, annular seal 110, for example, an O-ring or the like, can be located between second portion 108 of hollow portion 12 and second portion 102 of insulation 40.

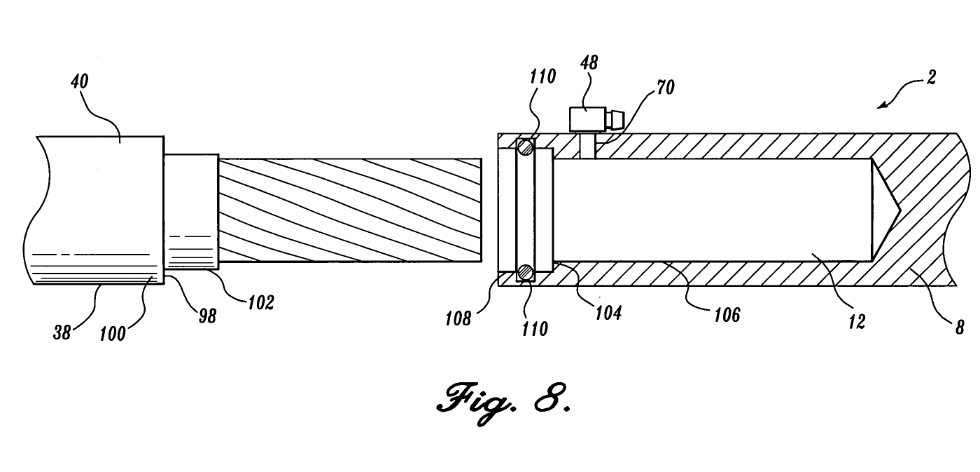

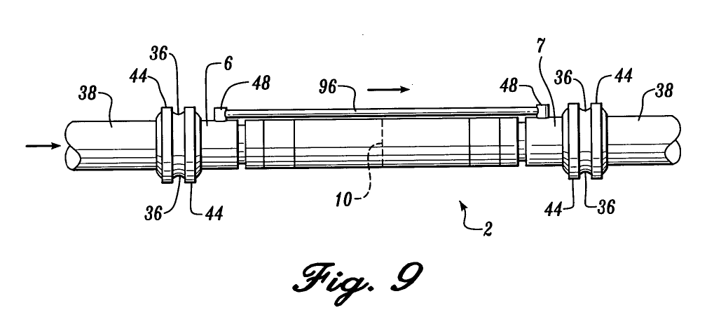

Referring to FIG. 9, a sixth embodiment of the present invention is shown having elements that are also present in the first embodiment of the present invention of FIG. 3, these like elements having the same element numbers as those used in the first embodiment of FIG. 3. In the sixth embodiment of FIG. 9, a configuration is shown which allows cable connector 2 to pass cable repair or desiccant fluids therethrough such that these fluids are originated only at one end of cable connector 2, i.e., end 6, and not at both ends 6 and 7 of cable connector 2, whereby cable repair or desiccant fluids flow in a single direction through cable connector 2. The above configuration is useful when cable connector 2 is located remotely from the initial injection point of the cable repair chemicals into cable 38. Thus, as shown in FIG. 9, tube 96 is employed to connect tube fitting 48 of end 6 with tube fitting 48 of end 7 such that cable repair chemicals entering end 6 of cable connector 2 are not blocked by interior wall 10, but instead pass through tube fitting 48 of end 6, through tube 96, through tube fitting 48 of end 7, and out of end 7 into the other portion of cable 38 which is joined by cable connector 2.

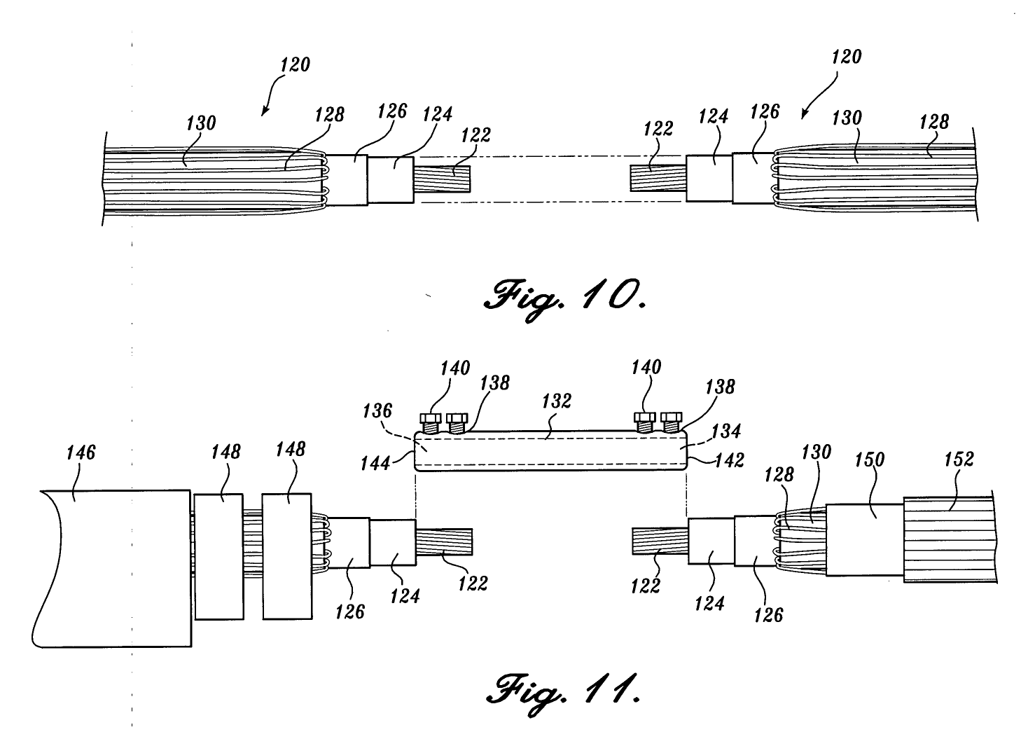

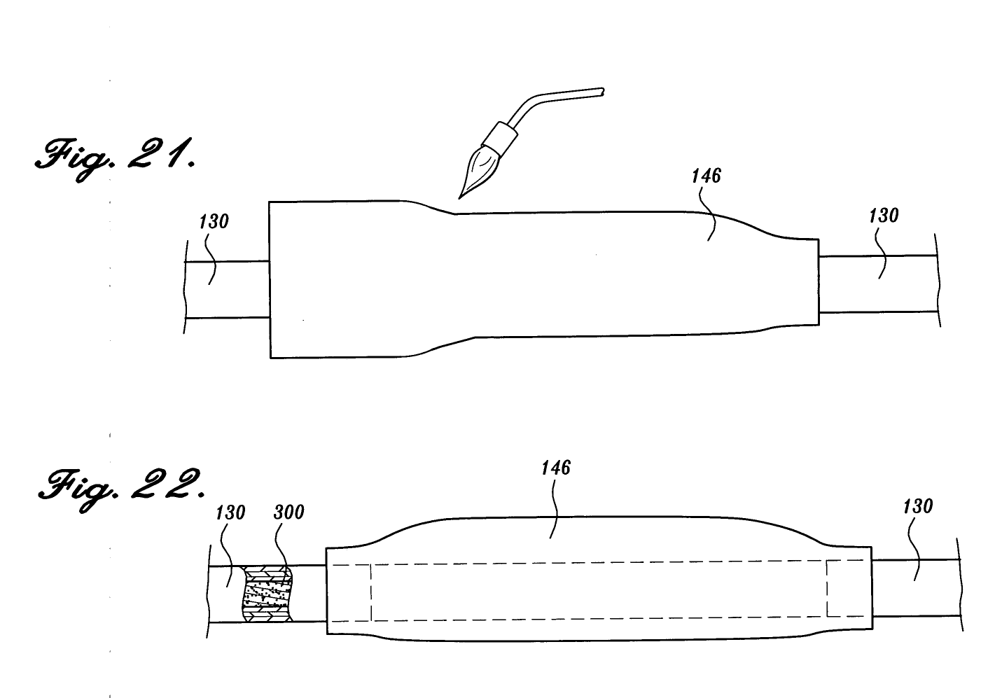

Referring to FIGS. 10-27, a seventh embodiment of the subject invention is shown, which includes an interior connector portion and an injection fitting portion. More specifically, referring to FIG. 10, electrical cable sections 120 are shown after being prepared for attachment to the interior connector components of the seventh embodiment of the subject invention. Electrical cable sections 120 each include a central core 122 that is surrounded by insulation 124. Core screen 126 covers insulation 124. Shielding wires 130 cover core screen 126. Oversheath 130, which is optional, covers shielding wires 128. The electrical cable sections 120 are each prepared by removing a portion of insulation 124 to expose central core 122. Also, a portion of core screen 126 is removed to expose insulation 124. Shielding wires 128 are bent away from central core to lie substantially parallel to the longitudinal axis of electrical cable section 120.

As will be further described below, conduit 132 of the interior connector portion of the subject invention will electrically connect each central core 122 of electrical cable sections 120. Conduit 132 will abut the exposed ends of insulation 124 of each of electrical cable sections 120; it is therefore important to ensure that the structural integrity of insulation 124 remains undamaged and that its surface is free from any previous jointing material if conduit 132 serves as a replacement splice.

Referring to FIG. 11, attachment of conduit 132 to the central core 122 of each electrical cable section 120 is shown. Conduit 132 is an elongate hollow electrically conductive tubular member having a first end 134 and a second end 136. Adjacent to first end 134 and second end 136 of conduit 132 are a plurality of threaded openings 138; preferably, between two and four threaded openings 138 are present adjacent each of first end 134 and second end 136. Threaded openings 138 are sized to receive bolts 140. Bolts 140 are preferably of a length sufficient to contact central core 122 of electrical cable section 120 when bolts 140 are tightened without impeding the flow of cable repair chemicals through electrical cable sections 120. As stated above, conduit 132 is hollow, and therefore has an opening 142 and 144 adjacent first end 134 and second end 136, respectively.

Still referring to FIG. 11, prior to attaching conduit 132 to central core 122 of the electrical cable sections 120, additional components of the interior connector portion of the subject invention are placed over the two electrical cable sections 120. More specifically, outer sheath 146 is first placed over one of the two electrical cable sections 120. Next, at least two compression rings 148 are placed over the same electrical cable section 120 such that the compression rings 148 are located adjacent to outer sheath 146, and in closer proximity to the end of the electrical cable section 120. Stress control tubing 150 is placed over the other electrical cable section 120, and insulation sleeve 152 is placed over stress control tubing 150. Stress control tubing 150, as described further below, is located over conduit 132, which connects the two electrical cable sections 120. Stress control tubing 150 is employed to provide electrical stress control around the joint. Stress control tubing 150 is preferably made of a carbon-based filler in a heat shrinkable polymer matrix. Insulation sleeve 152 provides electrical insulation and screening, as well as sealing. Insulation sleeve 152 is preferably made of an insulating elastomer with an external conductive screen. Compression rings 148, as will be discussed further below, provide a fluid tight seal over the points of attachment of stress control tubing 150 and insulation sleeve 152 to the electrical cable sections 120. Compression rings 148 are preferably comprised of a high density polyethylene-based cross-linked material. Outer sheath 146 is the exterior layer of the interior connector portion of the cable connector of the seventh embodiment of the present invention. Outer sheath 146 is preferably comprised of a heat shrink material, such as low density polyethylene-based cross-linked material, and provides protection from the external environment. Preferably, all of outer sheath 146, compression rings 148, stress control tubing 150, and insulation sleeve 152 are comprised of a heat shrink material such that the application of sufficient thermal energy will cause the structure to shrink in diameter in order to ensure a fluid-tight fit.

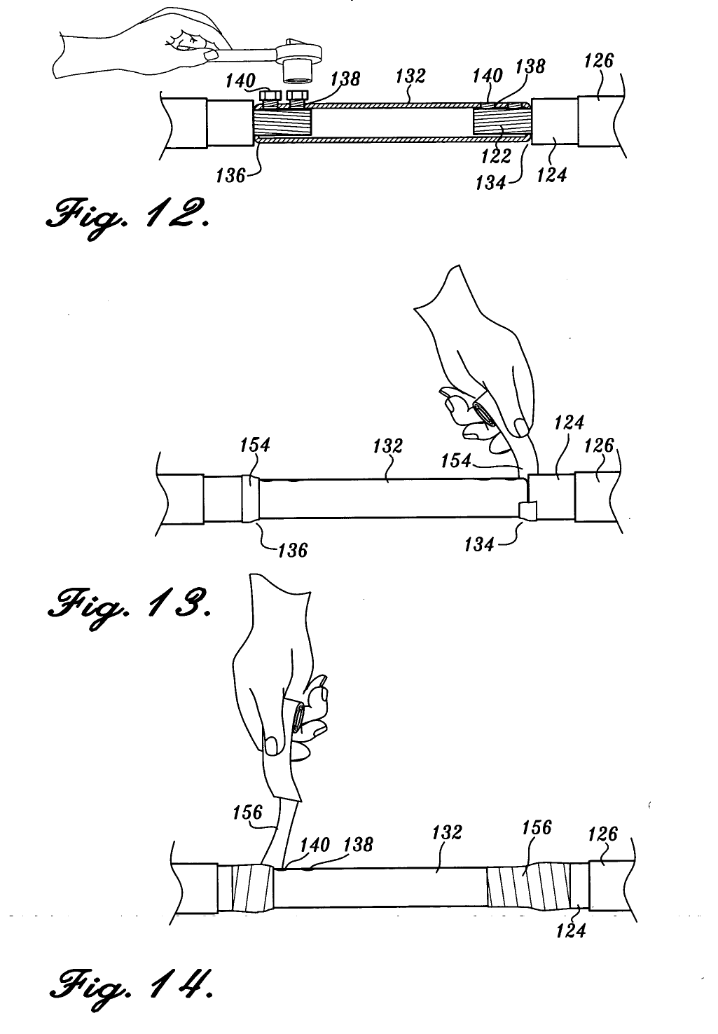

Referring to FIG. 12, conduit 132 is attached to central core 122 of each of the cable sections 120 by insertion of central core 122 (that has been exposed by removing a portion of insulation 124 therefrom) into one of openings 142 and 144 of first end 134 and second end 136, respectively, of conduit 132. Bolts 140 are then placed in threaded openings 138 of conduit 132. Bolts 140 are hand tightened. Bolts 140 are preferably shear bolts such that the application of sufficient torque thereto will cause the heads of bolts 140 to shear off. As shown in FIG. 12, a ratchet or wrench is employed to provide sufficient torque for the heads of bolts 140 to shear off. Next, the gaps created in threaded openings 138 by the removal of the heads of bolts 140 are filled with sealing clay, for example, Raychem clay electrical grade filler. Next referring to FIG. 13, the joints between first end 134 and second end 136 of conduit 132 with insulation 124 of the electrical cable sections 120 are covered with rubber tape 154 having an elastomeric property such that the tape can be stretched to about one half of its original width to ensure a tight seal. Rubber tape 154 is wrapped over conduit 132 and the insulation 124 of electrical cable sections 120 such that rubber tape 154 covers at least one-half inch of conduit 132 and one-half inch of insulation 124 on both first end 134 and second end 136 of conduit 132. Next, referring to FIG. 14, a void-filling tape 156, preferably Raychem stress grading yellow void filling mastic, is wrapped over conduit 132, insulation 124 and rubber tape 154. More specifically, void-filling tape 156 has elastomeric properties such that it can be stretched to about one half of its original width during the wrapping process. Void-filling tape 156 is wrapped over a sufficient portion of first end 134 and second end 136 of conduit 132 to cover threaded openings 138 in which sheared bolts 140 are located. Void-filling tape 156 can also optionally be employed to wrap the juncture of insulation 124 and core screen 126 formed by removal of a portion of core screen 126 to expose insulation 124.

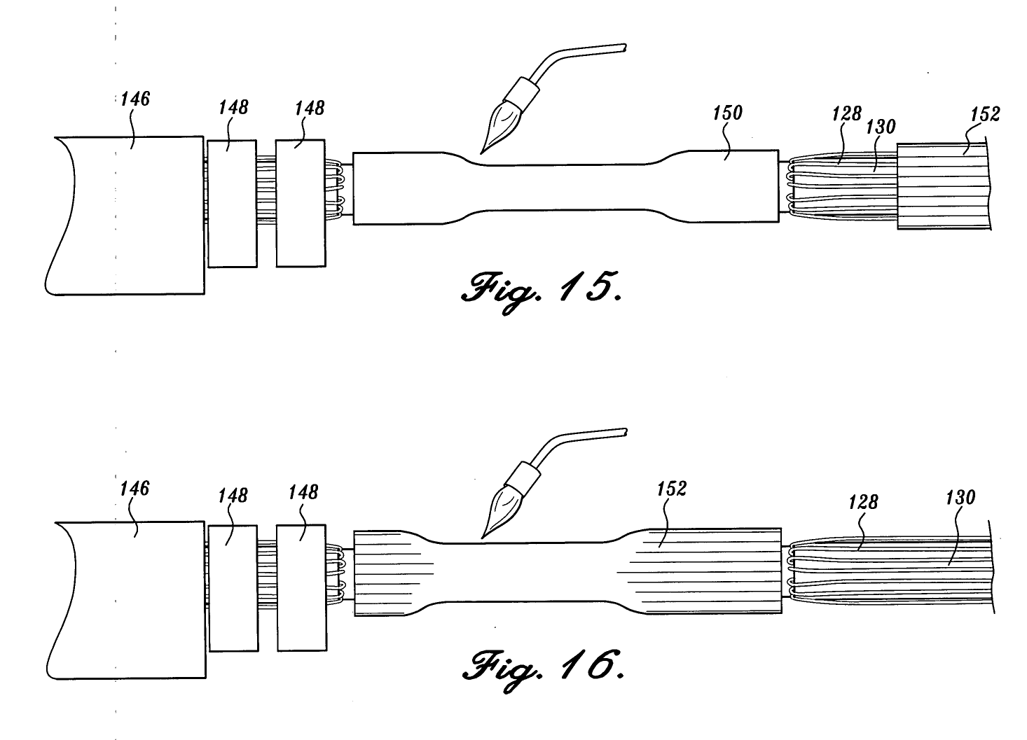

Referring to FIG. 15, stress control tubing 150, which had previously been located over one of the two electrical cable sections 120, is now moved to cover conduit 132 connecting the two electrical cable sections 120. The stress control tubing 150 is of sufficient length to cover conduit 132, the exposed portion of insulation 124, and a portion of core screen 126. A thermal heat source, such as a propane torch, is employed to shrink stress control tubing 150. More specifically, shrinking is started at the center of stress control tubing 150 and is worked outwardly to both ends thereof in order to ensure that stress control tubing 150 is completely shrunk and substantially wrinkle free.

Referring to FIG. 16, insulation sleeve 152, which has previously been located over the same electrical cable section 120 as was stress control tubing 150, is now moved to cover stress control tubing 150, which has been heat shrunk over conduit 132. insulation sleeve 152 is of sufficient length to substantially cover stress control tubing 150. insulation sleeve 152 is heat shrunk with a thermal energy source, such as a propane torch, by first shrinking the center portion of insulation sleeve 152 until a sufficient portion of insulation sleeve 152 has been heat shrunk so insulation sleeve 152 does not rotate with respect to electrical cable sections 120 when an attempt is made to twist it by hand. Next, one of the two outer portions of insulation sleeve 152 is heat shrunk; however, the exterior end of the outer portion being heat shrunk is not heat shrunk at this time. The other outer portion of insulation sleeve 152 is then heat shrunk, again leaving the end of this outer portion unshrunk. The end of the first outer portion to be heat shrunk is then heat shrunk. Finally, the end of the second outer portion is heat shrunk to complete the process.

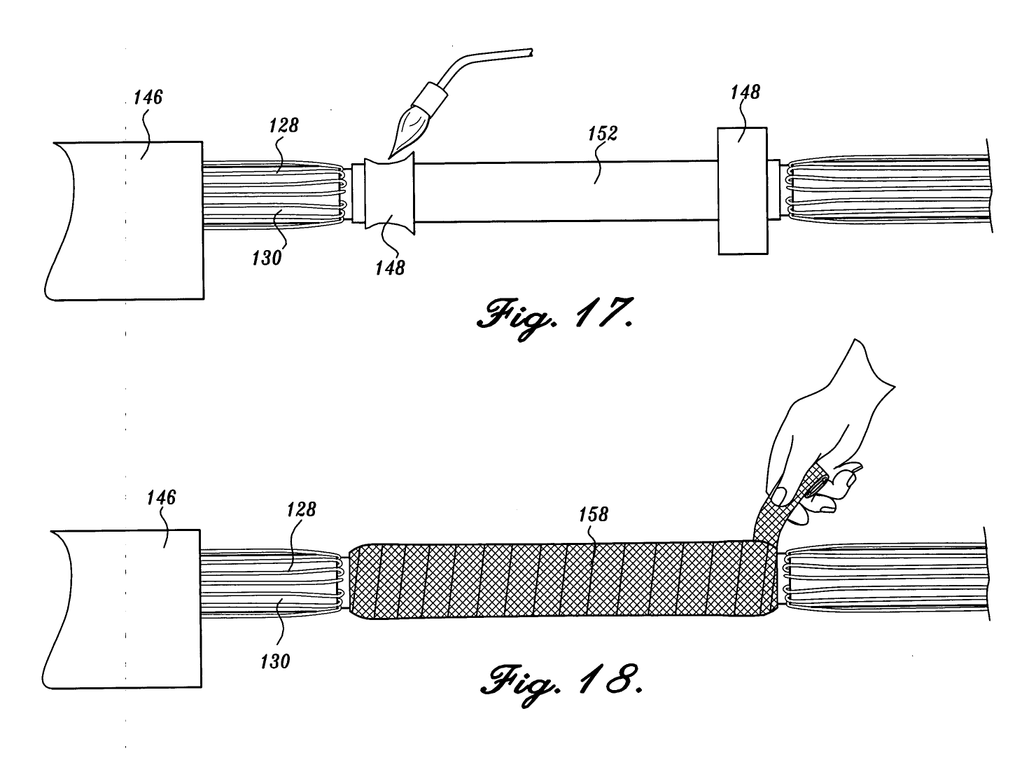

As shown in FIG. 17, compression rings 48, which were located on one of the two electrical cable sections 120 are moved over insulation sleeve 152 while insulation sleeve 152 is still hot from heat shrinking. One compression ring 148 is oriented at each of the two ends of insulation sleeve 152. Compression rings 148 are then heat shrunk with a propane torch, for example, onto insulation sleeve 152.

Referring to FIG. 18, an alloy braid 158, comprised of, for example, copper alloy, is wrapped over insulation sleeve 152 and compression rings 148. As shown in FIG. 19, shielding wires 128 from each of electrical cable sections 120 are bent from their configuration away from the work area to now be positioned over alloy braid 158. The ends of each shielding wire 128 group are coupled to a connector 160. The two connectors 160 are then connected by a wire lead 162 to interconnect the two shielding wire 128 groups.

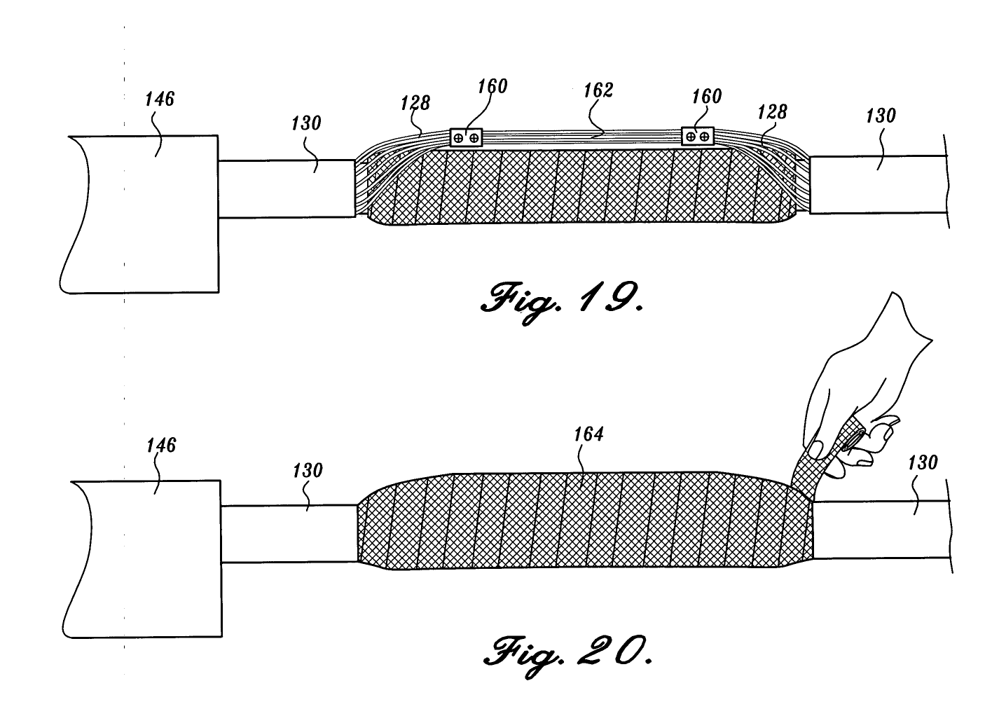

As shown in FIG. 20, outer sheath 146 is moved from its position over one of the electrical cable sections to cover alloy braid 164. Outer sheath 146 is heat shrunk with, for example, a propane torch, starting at the center of outer sheath 146 and working toward the outer edges thereof until outer sheath 146 tightly encases alloy braid 164. The above-detailed configuration of the interior connector portion of the seventh embodiment of the present invention, as shown in FIGS. 11-22, facilitates the passage of cable repair chemicals through electrical cable sections 120 while maintaining electrical conductivity between the two electrical cable sections 120.

Referring to FIGS. 23-28, the injection fitting portion of the seventh embodiment of the subject invention is shown. Specifically referring to FIG. 23, an electrical cable section 120 having a central core 122 is shown. It should be noted that the injection fitting portion of the subject invention, to be described further below, can be connected to an exterior end of an electrical cable section 120 whereby the interior end of this same electrical cable section 120 is interconnected with the interior end of another electrical cable section 120 by the above-described interior connector portion of the subject invention of FIGS. 11-20. As shown in FIG. 23, injection fitting 176 of the seventh embodiment of the present invention is connectable to a cable splice 178 that can be, for example, Elastomold model No. M650S or model No. 755LR. Cable splice 178 includes splice housing 180, a hollow member that is removably attachable to splice base 182. The end of splice housing 180 remotely located from splice base 182 includes adaptor opening 184 in which cable adaptor 186 can be located. Cable adaptor 186 is a collar attachable to electrical cable section 120, preferably around insulation 124. Cable splice 178 also includes conductor contact 188 that has an end attachable to the end of central core 122 of electrical cable section 120. The end of conductor contact 188 remote from central core 122 of electrical cable section 120 is attachable to splice base 182 by bolt 190. In this manner, conductor contact 188 provides electrical interconnection between central core 122 of electrical cable section 120 and cable splice 178. Unlike prior art configurations of cable splice 178, cable splice 178 as shown in relation to the present invention has a relatively truncated cable adaptor 186 such that a portion of central core 122 of electrical cable section 120 between cable adaptor 186 and conductor contact 188 is exposed and not covered by cable adaptor 186. This configuration facilitates the orientation of injection sleeve 192 of injection fitting 176 over the exposed portion of insulation 124 to cover cable core 122 of electrical cable section 120. More specifically, injection sleeve 192 is oriented over both insulation 124 and contact end 194 of conductor contact 188 to form a fluid injection chamber 196 in which central core 122 of electrical cable section 120 is located. Injection port 198 is located in injection sleeve 192 to provide fluid communication into fluid injection chamber 196 such that repair chemicals can be injected into injection port 198 to enter fluid injection chamber 196 and pass into central core 122 of electrical cable section 120. These repair chemicals can pass through this electrical cable section 120 and into a second electrical cable section 120 if the two electrical cable sections 120 are interconnected by the interior connector portion of the present invention as shown in FIGS. 11-22. However, it will be readily understood by one skilled in the art that the above-described interior connector portion of the subject invention of FIGS. 11-22 and the present injection fitting 176 can be used either in concert with or separately from one another to facilitate flow of cable repair chemicals through one or more electrical cable sections 120.

Referring to FIGS. 24-28, injection sleeve 192 and various embodiments of injection port 198 are described in detail. Injection sleeve 192 is preferably comprised of polyethylene applied with a hot melt adhesive. Most preferably, injection sleeve 192 is comprised of a heat shrink material such that the application of thermal dynamic energy from a thermal source, such as a propane torch or the like, facilitates a fluid tight fit of injection sleeve 192 over both insulation 124 of electrical cable section 120 and contact end 194 of conductor contact 188. As shown in FIG. 24, in a first embodiment, injection port 198 can be an opening that is drilled into injection sleeve 192 after injection sleeve 192 has been heat shrunk and has cooled. This opening is then tapped with internal threads to facilitate a threaded interconnection between injection sleeve 192 and a cable repair chemical source having an externally threaded connector (not shown).

Referring to FIG. 25, a second embodiment of injection port 198 is shown. In this second embodiment, a hole defining injection port 198 is first drilled in injection sleeve 192 prior to heat shrinking thereof. This hole is tapped and a temporary externally threaded fitting 200 is placed in the hole. Injection sleeve 192 is then heat shrunk in the manner described above and the externally threaded fitting 200 is removed, leaving an internally threaded injection port 198 through which cable repair chemicals can pass from a cable repair chemical source having an externally threaded connector (not shown).

Referring to FIG. 26, a third embodiment of injection port 198 is shown. In this third embodiment, a hole is drilled in injection sleeve 192 prior to shrinking thereof. Internally threaded bushing 202 defining the injection port 198 is placed in the hole and adhesively connected to injection sleeve 192. Injection sleeve 192 is then heat shrunk in the manner described above, and cable repair chemicals can pass through injection port 198 by attachment of an externally threaded connector from a cable repair chemical source (not shown) to externally threaded bushing 202.

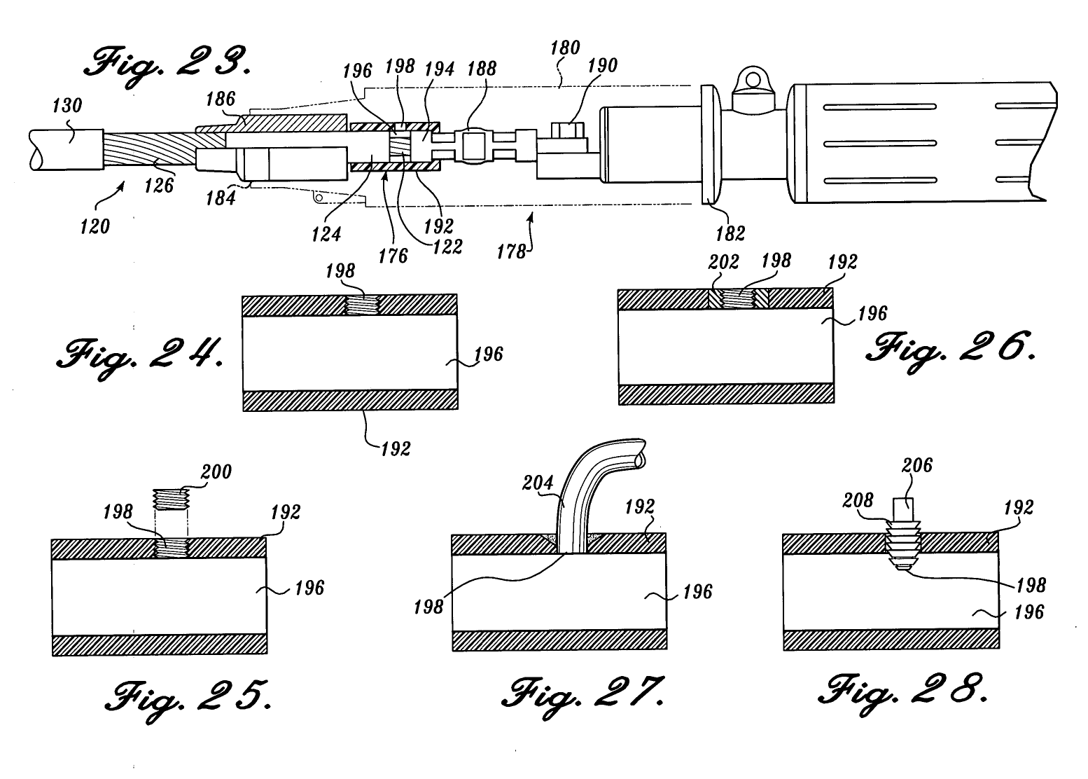

Referring to FIG. 27, a fourth embodiment of injection port 198 is shown. In this embodiment, injection sleeve 192 is first heat shrunk in the manner as described above. Next, a hole is drilled into injection sleeve 192, forming injection port 198. A tube preferably comprised of a synthetic polymer is inserted in injection port 198 and is sealed onto injection sleeve 192 by using a thermal adhesive, hot air, or ultrasonic energy in a manner known in the art.

Referring to FIG. 28, a fifth embodiment of injection port 198 is shown. In this embodiment, injection sleeve 192 is first heat shrunk in the manner described above and is allowed to cool. A hole defining injection port 198 is drilled into injection sleeve 192. Tube 206 is inserted in injection port 198. Tube 206 has a plurality of angularly disposed fins 208. Fins 208 are angled outwardly with respect to fluid injection chamber 196 such that tube 206 can readily be inserted into injection port 198, but removal of tube 206 from injection port 198 is hampered by fins 208. Additionally, fins 208 provide a physical block to prevent seepage of fluid from between tube 206 and injection sleeve 192.

Those skilled in the art will recognize that the subject invention can be used in low, medium, or high voltage environments, and is also applicable for the use of air drying techniques for cable water contamination in addition to the above described water damage repair chemical application.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A connector for a first information transmitting cable, the first information transmitting cable having an outer surface, an interior end, an exterior end, and a central conductor portion, the connector comprising:
a first conduit having open ends.
